(19) United States
(12) Patent Application Publication
(10) Pub. No.: US 2014/0309397 A1
(43) Pub. Date: Oct. 16, 2014

(54) Polyurethane Elastomers Based on TDI Prepolymers Enriched in the 2,6-TDI Isomer Cured with Trimethylene Glycol Di-(para Amino Benzoate)

(71) Applicant: ANDERSON DEVELOPMENT COMPANY, ADRIAN, MI (US)

(72) Inventors: ROBERT A. CZEISZPERGER, PITTSFORD, MI (US); JORDAN M. DUCKETT, CLINTON, MI (US); STEPHEN D. SENEKER, ADRIAN, MI (US)

(73) Assignee: ANDERSON DEVELOPMENT COMPANY, ADRIAN, MI (US)

(21) Appl. No.: 13/860,986

(22) Filed: Apr. 11, 2013

(51) Int. Cl. C08G 18/32

(52) U.S. Cl. CPC C08G 18/3203
USPC 528/85

(57) ABSTRACT

Polyurethane/urea elastomer compositions which retain their dimensions at elevated temperatures. These polyurethane/urea elastomers surprisingly have improved green strength or dimensional stability upon demolding at typical mold temperatures of 80 to 130 C and remain dimensionally stable throughout the post cure process which is typically overnight at about 100 C. They are useful in indirect food contact or dry food contact applications since the compositions use trimethylene glycol di(p-aminobenzoate) as a chain extender or curative. The polyurethane/urea elastomers may be prepared by reacting toluene diisocyanate prepolymers with trimethylene glycol di(p-aminobenzoate). The toluene diisocyanate prepolymers are reaction products of toluene diisocyanate containing at least 25% by weight of the 2,6-isomer, preferentially at least 35%, more preferentially at least 45%, and most preferentially 60% with polyols such as polyoxyalkylene polyether polyols like polytetramethylene glycol, polypropylene glycol and polyethylene glycol, polyester polyols, polycaprolactone polyols, polycarbonate polyols, polybutadiene polyols or mixtures thereof.

### TECHNICAL FIELD

Embodiments of the present disclosure relate to compositions of hot-cast, heat-cured, molded polyurethane/urea elastomers, which may have improved retention of their dimensions at elevated temperatures. Specifically, certain embodiments relate to polyurethane/urea elastomer compositions, which may have improved green strength or dimensional stability upon demolding at typical mold temperatures of 80 to 130 C and remain dimensionally stable throughout the post cure process which is typically overnight (e.g., for at least 4 hours, or at least 8 hours, or at least 12 hours) at about 100 C. Embodiment of these polyurethane/urea elastomers may be useful in industrial wheel and tires, rolls and coverings, belts, mechanical goods, mining and oilfield, and recreational and sport applications. In particular, certain embodiments may be useful in indirect food contact or dry food contact applications according to the Code of Federal Regulations 21 CFR 177.1680 since embodiments of the polyurethane/urea elastomer compositions use trimethylene glycol di-(p-aminobenzoate) as a chain extender or curative.

### BACKGROUND ART

The preparation of polyurethane and polyurethane/urea elastomers by reacting a diisocyanate with a polyol and then chain extending with a short chain diol or aromatic diiamine to form the elastomer is well known. Three processes are used, the prepolymer process, the quasi process, and the one-shot process as described in I. R. Clemitson, “Castable Polyurethane Elastomers”, CRC Press, 2008, pp. 41-65. A diisocyanate widely used in the prepolymer process is toluene diisocyanate. Toluene diisocyanate prepolymers are typically extended or cured with aromatic diamines. The most common aromatic diamines are methylene bis(ortho dichloroaniline) (MBOCA), 3,5-diethyl-2,4-toluene diamine and 3,5-diethyl-2,6-toluene diamine or mixtures thereof (Ethacure® 100), 3,5-dimethylthio-2,4-toluene diamine and 3,5-dimethylthio-2,6-toluene diamine or mixtures thereof (Ethacure® 300), 4,4′-methylene bis(3-chloro-2,6-diethylaniline) (Lonzacure® MCDEA) and trimethylene glycol di-(p-aminobenzoate) (Versalink® 740M). The resulting elastomers are used in a variety of applications including industrial wheel and tires, rolls and coverings, belts, mechanical goods, mining and oilfield, and recreational and sport applications. However, of all the above chain extenders or curatives, only trimethylene glycol di-(p-aminobenzoate) is approved for indirect food contact or dry food contact applications according to the Code of Federal Regulations 21 CFR 177.1680.

Below is a description of the known art for rubber like materials that are approvable for indirect food contact or dry food contact applications according to the Code of Federal Regulations 21 CFR 177.1680.

For softer indirect food contact elastomers with a Shore A hardness of 55 A or less, one typically uses toluene diisocyanate prepolymers cured with trimethylol propane. However, these elastomers have a limited hardness range of 55 A or less and they have inferior tear strength.

For indirect food contact elastomers with a Shore hardness above 55 A, one can use toluene diisocyanate prepolymers cured with trimethylene glycol di-(p-aminobenzoate). Using these compositions, one can achieve a hardness from about 60 Shore A up to an 80 Shore D. Using this approach results in elastomers which do not crack or tear easily while demolding. However, using conventional toluene diisocyanate prepolymers prepared with 100/0 2,4-/2,6-toluene diisocyanate or low-free toluene diisocyanate prepolymers prepared with 100/0 2,4-/2,6-toluene diisocyanate or 80/20 2,4-/2,6-toluene diisocyanate and then cured with trimethylene glycol di-(p-amino benzoate) give polyurethane/urea elastomers with inferior green strength or dimensional stability at the typical mold temperatures of 80 to 130 C. This results in elastomer parts which do not retain their dimensions or shape during and after demolding. As a result, manufacturers have to place the parts in fixtures to hold their shape after demolding and during the post cure process which is typically overnight at 100 C. This process is laborious and inefficient. So it is an objective for certain embodiments of this disclosure to provide compositions which give dimensionally stable parts during the demolding process and throughout the post cure process eliminating or reducing the need for fixtures.

Another current approach used for obtaining indirect food contact or dry food contact compliant elastomers is to use compositions compliant for direct wet food contact according to the United States Code of Federal Regulations 21 CFR 177.2600 such as rubber compositions. However, polyurethane and polyurethane/urea elastomers have significant advantages over rubber compositions. For example, the processing of rubber compositions requires expensive high pressure molds and more steps to process than polyrurethane or polyurethane/urea elastomers. Polyurethane and polyurethane/urea elastomers also have significantly improved properties over rubber compositions such as improved oil resistance, load carrying capacity, ozone resistance and abrasion resistance. So it is an additional objective for certain embodiments to provide compositions with improved processing and properties versus rubber compositions.

There are two polyurethane elastomer compositions which are compliant for direct wet food contact according to the United States Code of Federal Regulations 21 CFR 177.2600 which can also be used for indirect food contact or dry food contact applications according to the Code of Federal Regulations 21 CFR 177.1680. They are derived from the reaction of diphenylmethane diisocyanate, polytetramethylene glycol and 1,4-butanediol and the reaction of diphenylmethane diisocyanate, polybutylene adipate polyol and 1,4-butanediol. These polyurethane elastomers can be used in indirect food contact or dry food contact applications, however, they do have some significant disadvantages in comparison to polyurethane/urea elastomers based on toluene diisocyanate prepolymers chain extended or cured with trimethylene glycol di-(p-aminobenzoate). According to U.S. Pat. No. 5,849,944 and I. R. Clemitson, “Castable Polyurethane Elastomers”, CRC Press, 2008, pp. 73-74, polyurethane elastomers based on diphenylmethane diisocyanate are known to have inferior green strength or tear strength during the casting process which can result in cracks in the parts. Cracks in the parts result in a significantly high reject rate in comparison to toluene diisocyanate prepolymers cured with aromatic diiamines like trimethylene glycol di-(p-aminobenzoate). Diphenylmethane diisocyanates based polyurethane elastomers also have a tendency to foul the molds which require the molds to be cleaned more frequently thus lowering productivity. Additionally, polyurethane elastomers based on diphenylmethane diisocyanate have an inferior upper hardness limit of about 60 Shore D, whereas, toluene diisocyanate prepolymers cured with aromatic diamines like trimethylene glycol di-(p-aminobenzoate) can achieve a hardness up to 80 Shore D. So it is an additional objective for certain embodiments of this disclosure to provide compositions that have improved processability in terms of higher tear strength during the casting process resulting in fewer reject parts and a high Shore D hardness limit.

Using conventional toluene diisocyanate prepolymers according to embodiments of the disclosure prepared with higher levels of 2,6-toluene diisocyanate such as 35% 2,6-toluene diisocyanate give polyurethane/urea elastomers of improved dimensional stability, however, the work life or pour time is short making it difficult to fill the mold prior to solidification. Conventional toluene diisocyanate prepolymers are typically composed of a 1.6 to 2.0 mole ratio of toluene diisocyanate to polyol. This results in a toluene diisocyanate prepolymer with a significant amount of unreacted toluene diisocyanate monomer of about 0.5 to 2.0 weight percent. Conventional toluene diisocyanate prepolymers suffer because the unreacted toluene diisocyanate monomer is volatile and toxic thus requiring special handling procedures. So it is preferred to use toluene diisocyanate prepolymers which have a low free, toluene diisocyanate monomer content which result in a longer work life or pour time and are safer to process.

Low free toluene diisocyanate prepolymers are prepared by reacting the toluene diisocyanate with the polyol and then stripping out the unreacted free toluene diisocyanate monomer using high temperature and vacuum. A thin film distillation process like a wiped film evaporator can be used to accomplish this. This process and the art which discloses the use of prepolymers with low free toluene diisocyanate contents is described in U.S. Pat. Nos. 4,182,825, 4,556,703 and 4,786,703. Low free toluene diisocyanate prepolymer typically have unreacted toluene diisocyanate contents of less than or equal to 0.5 weight percent and preferentially less than or equal to 0.1 weight percent.

Art describing the use of 2,6-toluene diisocyanate contents in low free toluene diisocyanate prepolymers includes U.S. Pat. Nos. 4,556,703, 4,786,703 and 6,964,626.

U.S. Pat. No. 4,556,703 discloses the preparation of polyurethane/urea elastomers using toluene diisocyanate that has 2,6-isomer content for the preparation of prepolymers. After the prepolymer formation the excess unreacted toluene diisocyanate monomer was removed. These prepolymers were cured with methylene bis-(orthochloro aniline) (MBOCA) and the resulting elastomers were found to having lower heat buildup on flexing. Even though this patent claims trimethylene glycol di-(p-aminobenzoate) as a curative it does not reduce it to practice and does not recognize the issue of dimensional stability because toluene diisocyanate prepolymers cured with MBOCA do not have dimensional stability problems when demolded at 80 to 130 C and post cured overnight at 100 C.

U.S. Pat. No. 4,786,703 discloses the use of 100% 2,6-isomer of toluene diisocyanate in the preparation of low free toluene diisocyanate prepolymers. These prepolymers were cured with MBOCA and compared to those using 20% 2,6-isomer. Elastomers prepared with the 100% 2,6-isomer gave improved high temperature performance and low hysteresis. This patent does not reduce to practice trimethylene glycol di-(p-aminobenzoate) and does not recognize the issue of dimensional stability because toluene diisocyanate prepolymers cured with MBOCA do not have this issue regardless of the 2,6-isomer content of the toluene diisocyanate.

U.S. Pat. Nos. 6,964,626 and 7,824,288 claim a power transmission belt having high temperature resistance to about 140 C using symmetrical diisocyanate which includes 2,6-toluene diisocyanate, an oxidatively resistant polyol and a symmetrical aromatic diamine which includes trimethylene glycol di-(p-aminobenzoate). However, these patents did not reduce to practice pure 2,6-toluene diisocyanate. U.S. Pat. No. 6,964,626 does give a comparative example (Example 19) which is not according to their invention using a conventional toluene diisocyanate prepolymer using 20% of the 2,6-isomer with a 1000 MW poly(hexamethylene carbonate) diol cured with trimethylene glycol di-(p-aminobenzoate) which gave inferior temperature resistance. Whereas, conventional toluene diisocyanate prepolymers based on at least 25% of the 2,6-isomer and cured with trimethylene glycol di-(p-aminobenzoate) according to the present disclosure show surprising improvements in the dimensional stability and green strength at demold and throughout the postcure process. U.S. Pat. No. 6,964,626 does not recognize the 2,6-toluene diisocyanate isomer effect on the green strength or dimensional stability of the elastomers during the demolding and post cure process.

Additionally, other common aromatic diamine chain extenders or curatives in addition to MBOCA that are used with toluene diisocyanate prepolymers such as 3,5-diethyl-2,4-toluene diamine and 3,5-diethyl-2,6-toluene diamine or mixtures thereof (Ethacure® 100), 3,5-dimethylthio-2,4-toluene diamine and 3,5-dimethylthio-2,6-toluene diamine or mixtures thereof (Ethacure® 300) (see “Ethacure 300 Curative—A Convenient Liquid For All Commercially Available Prepolymers”, Albemarle Corporation Technical Bulletin, 1997), and 4,4′-methylene bis(3-chloro-2,6-diethylaniline) (Lonzacure® MCDEA) (see “Lonzacure M-CDEA—The Superior Curative for the Polymer Industry”, Lonza LTD Technical Bulletin, 1992) result in polyurethane/urea elastomers with good dimensional stability upon demolding at 80 to 130 C and remain dimensionally stable throughout the post cure process which is typically overnight at about 100 C.

U.S. Pat. No. 5,166,299 claims toluene diisocyanate prepolymers with 2,6-isomer contents from 35 to 65% reacted with mixtures of 3,5-dimethylthio-2,4-toluene diamine and 3,5-dimethylthio-2,6-toluene diamine (Ethacure® 300). Elastomers based on toluene diisocyanate with higher 2,6-isomer contents resulted in wheels which ran cooler when under a load. Elastomers using 0, 20 and 35% 2,6-toluene diisocyanate levels were reduced to practice and all were dimensionally stable after demold and throughout the postcure process.

Whereas, polyurethane/urea elastomers prepared with 100/0 2,4-/2,6-toluene diisocyanate using trimethylene glycol di-(p-aminobenzoate) have inferior green strength or dimensional stability upon demolding at 80 to 130 C and do not retain their shape during the 100 C overnight post cure process. These elastomer composition often require fixtures to hold the dimensions and shape during the post cure process.

U.S. Pat. No. 3,554,872 discloses a method for enriching the 2,6-toluene diisocyanate isomer mixture. It shows reacting a 80/20 2,4-/2,6-toluene diisocyanate isomer mixture with a long chain diol at a mole ratio of about 3.5 to 1.0. The unreacted toluene diisocyanate was distilled via thin-film rotary evaporator resulting in a 32.4/67.6 2,4-/2,6-toluene diisocyanate isomer mixture. This process was repeated resulting in toluene diisocyanate 2,6-isomer of 99% purity.

U.S. Pat. No. 4,721,807 discloses a method for separating 2,6-toluene diisocyanate from isomers of toluene diiscyanate using a adsorbent comprising a Y-type zeolite cation exchanged with a potassium cation, thereby selectively adsorbing the 2,6-toluene diisocyanate. The 2,6-toluene diisocyanate is recovered by desorption.

### SUMMARY

It is an objective of certain embodiments of this disclosure to provide polyurethane/urea elastomers which give improved dimensional stability and green strength during the demolding process and throughout the post cure process using trimethylene glycol di-(p-aminobenzoate) as a curative.

It is an additional objective of certain embodiments to provide toluene diisocyanate prepolymer compositions which are uniquely adapted for preparing polyurethane/urea elastomers with improved processability in terms of improved dimensional stability and green strength during the demolding process and throughout the post cure process using trimethylene glycol di-(p-aminobenzoate) as a curative.

It has been surprisingly discovered that toluene diisocyanate prepolymers using 2,6-isomer contents of 25% or greater, preferentially 35% or greater, more preferentially 45%, and most preferentially 60% or greater result in polyurethane/urea elastomers with improved dimensional stability and green strength during the demolding process and throughout the post cure process using trimethylene glycol di-(p-aminobenzoate) as a curative.

### BRIEF DESCRIPTION OF THE DRAWINGS

FIG. 1 shows hardness versus cure time for Examples 1 (Comparative) and Examples 2-4.

FIG. 2 shows hardness versus cure time for Examples 2-4.

FIG. 3 shows hardness versus cure time for Example 5 (Comparative) and Examples 6-8

FIG. 4 shows hardness versus cure time for Examples 6-8.

FIG. 5 shows hardness versus cure time for Example 9 (Comparative) and Example 10.

FIG. 6 shows hardness versus cure time for Example 11 (Comparative) and Example 12.

FIG. 7 shows hardness versus cure time for Example 13 (Comparative) and Examples 14-15.

FIG. 8 shows hardness versus cure time for Example 16 (Comparative) and Example 17.

### DESCRIPTION OF THE PREFERRED EMBODIMENTS

The polyurethane/urea elastomers of embodiments of the disclosure may be the reaction products of toluene diisocyanate prepolymers with trimethylene glycol di-(p-aminobenzoate). The toluene diisocyanate prepolymers may be the reaction products of toluene diisocyanate with at least 25% by weight of the 2,6-isomer with a polyol selected from the group of polyalkylene oxide, polyester, polycaprolactone, polybutadiene, polycarbonate, polycarbonate ester or mixtures thereof and optionally a short chain diol up to about 70% equivalents based on the total equivalents of polyol and short chain diol.

All the various reactants are known to the art. Toluene diisocyanate has two isomers which are the 2,4-toluene diisocyanate and the 2,6-toluene diiocyanate. The toluene diisocyanate suitable for the preparation of the toluene diisocyanate polymers of embodiments of this disclosure contain at least 25% by weight of the 2,6-isomer, preferentially at least 35% of the 2,6-isomer, more preferentially at least 45% of the 2,6-isomer, and most preferentially at least 60% of the 2,6-isomer.

The polyols useful in the toluene diisocyanate prepolymers used in embodiments of the present disclosure are also generally known in the art. Suitable polyols include but are not limited to the group of polyalkylene oxide, polyester, polycaprolactone, polybutadiene, polycarbonate, polycarbonate ester or mixtures thereof.

The polyalkylene oxide polyols used in embodiments of the present disclosure are generally prepared by well-known methods, for example by the base catalyzed addition of an alkylene oxide such as ethylene oxide, propylene oxide or butylene oxide or mixtures thereof onto an initiator molecule containing on average two or more active hydrogens. Examples of preferred initiator molecules are dihydric compounds such as ethylene glycol, propylene glycol, 1,6-hexanediol, resorcinol, bisphenols, aniline and other aromatic monoamines, aliphatic monoamines, and monoesters of glycine; trihydric compounds such as glycerine, trimethylol propane, trimethylol ethane; other polyhydric compounds include ethylene diamine, propylene diamine, methylenedianiline, toluene diamine, sorbitol and sucrose. Addition of the alkylene oxide to the initiator molecule may take place simultaneously or sequentially when more than one alkylene oxide is used resulting in block, random and block/random polyalkylene oxide polyols. Preferable polyalkylene oxide polyols used in embodiments of this disclosure are diols based on propylene oxide and ethylene oxide and mixtures thereof. It is also preferable to use polyether polyols having low levels of unsaturation.

Another polyalkylene oxide polyol used in embodiments of the present disclosure is polytetramethylene ether glycol. Polytetramethylene ether glycol is commonly prepared by acid-catalyzed polymerization of tetrahydrofuran.

The polyester polyols used in embodiments of the present disclosure include but are not limited to the reaction products of polyols, preferably diols, optionally with the addition of triols, and polycarboxylic acids, preferably dicarboxylic acids. Polycarboxylic acid anhydrides and the corresponding polycarboxylic esters or lower alcohols can also be used preparing polyesters. The polycarboxylic acids may be aliphatic, cycloaliphatic and/or aromatic in nature. The following are examples but not limited to: succinic acid, adipic acid, suberic acid, azelaic acid, sebasic acid, phthalic acid, isophthalic acid, trimellitic acid, phthalic acid anhydride, tetrahydrophthalic acid anhydride, hexahydrophthalic acid anhydride, tetrachlorophthalic acid anhydride, tetrachlorophthalic acid anhydride, endomethylene tetrahydrophthalic acid anhydride, glutaric acid anhydride, fumaric acid, dimeric and trimeric fatty acids, optionally mixed with monomeric fatty acids, dimethylterephthalate and terephthalic acid-bis-glycol esters. Suitable polyols used to produce such polyesters include but are not limited to the following: ethylene glycol, diethylene glycol, triethylene glycol, 1,2- and 1,3-propylene glycol, dipropylene glycol, tripropylene glycol, 1,4-, 1,3- and 2,3-butylene glycol, 1,6-hexanediol, 1,8-octanediol, 1,10-decanediol, neopentyl glycol, 1,4-cyclohexane dimethanol, 1,4-bis-hydroxymethylcyclohexane, 2-methyl-1,3-propanediol, glycerol, trimethylolpropane, 1,2,6-hexanetriol, 1,2,4-butanetriol, trimethylolethane, and mixtures thereof. Polyesters of lactones, such as ε-caprolactone, and hydroxycarboxylic acids, such as ω-hydroxycaproic acid, may also be used.

Another polyol that is suitable for embodiments of this disclosure is polybutadiene polyols. Polybutadiene polyols are prepared by the polymerization of butadiene. They are available with hydroxyl functionalities between 1.9 and 2.5

Suitable polycarbonate polyols are known to the art and may be prepared by the reaction of diols such as 1,3-propanediol, 1,4-butanediol, 1,6-hexanediol, 1,10-decanediol, neopentyl glycol, diethylene glycol, triethylene glycol, or tetraethylene glycol, and mixtures thereof, with diaryl carbonates, such as diphenyl carbonate, diethylene carbonate, dimethyl carbonate or phosgene.

The preferred polyols for embodiments of this disclosure are polypropylene glycol, polypropylene glycol containing ethylene oxide moieties, polytetramethylene glycol, adipic acid based polyester polyols, polycaprolactone, polybutadiene, polycarbonate, polycarbonate ester or mixtures thereof with equivalent weights in the range of 200 to about 4000, more preferably from about 250 to 2000. The more preferred polyols are polypropylene glycol, polypropylene glycol containing ethylene oxide moieties, polytetramethylene glycol and adipic acid based polyester polyols since these are approved for dry food contact applications according to the Code of Federal Regulations 21 CFR 177.1680.

The short chain diols used in embodiments of the present disclosure include but are not limited to ethylene glycol, diethylene glycol, triethylene glycol, 1,2- and 1,3-propylene glycol, dipropylene glycol, tripropylene glycol, 1,4-, 1,3- and 2,3-butanediol, neopentyl glycol, 1,6-hexanediol, 1,8-octanediol, 1,10-decanediol, 1,4-cyclohexane dimethanol, 1,4-bis-hydroxymethylcyclohexane, 2-methyl-1,3-propanediol, 250 MW polytetramethylene glycol or mixtures thereof. Small amounts of short chain triols such as trimethylolpropane, trimethylolethane and glycerine or mixtures thereof can also be used.

The preparation of toluene diisocyanate prepolymers through the reaction of toluene diisocyanate and a polyol or polyol mixture is well known in the art. The polyol or polyol mixture can contain up to about 70% equivalence of a short chain diol based on the total. For a conventional toluene diisocyanate prepolymer, the ratio of toluene diisocyanate to polyol expressed as a stoichiometric ratio of isocyanate/hydroxyl (NCO:OH) is from about 1.4:1.0 to 2.5:1. It is more preferable for the NCO:OH ratio to be from about 1.6:1.0 to 2.0:1.0. For a toluene diisocyanate prepolymer prepared using the low free toluene diisocyanate process an NCO:OH ratio of from about 2:1 to 20:1 is used, more preferably from about 3:1 to 6:1. The excess unreacted free toluene diisocyanate is removed using heat and vacuum to a level of less than about 0.5 weight percent, more preferably less than about 0.15 weight percent and most preferably less than about 0.10 weight percent. The toluene diisocyanate prepolymers from both the conventional and low free toluene diisocyanate processes of embodiments of the present disclosure include an isocyanate content of about 1 to 12%, more preferably from 2 to 10%. If desired, a small amount of stabilizer, such as benzoyl chloride or phosphoric acid, may be added into the toluene diisocyanate prepolymer during its preparation.

The toluene diisocyanate prepolymers of embodiments of the present disclosure are reacted with trimethylene glycol di-(p-aminobenzoate) as a curative or chain extender as known in the polyurethane/urea elastomer art. The polyurethane/urea elastomers of embodiments of the present disclosure utilize a toluene diisocyanate prepolymer to trimethylene glycol di-(p-aminobenzoate) equivalent ratio of about 0.8 to 1.2, more preferably 0.95 to 1.10 and most preferably 1.00 to 1.10.

The curative containing trimethylene glycol di-(p-aminobenzoate) may also contain other polyamine or polyol curatives known in the polyurethane/urea elastomer art. Examples of polyamines include 4,4′-diamino diphenyl methane, 4,4′-methylene-bis-(3-chloro-2,6-diethylaniline), 4,4′-methylene-bis-(ortho-chloroaniline), 3,5-diethyl-2,4-toluene diamine and 3,5-diethyl-2,6-toluene diamine or mixtures thereof, 3,5-dimethylthio-2,4-toluene diamine and 3,5-dimethylthio-2,6-toluene diamine or mixtures thereof and the like. Examples of polyols include ethylene glycol, diethylene glycol, triethylene glycol, 1,2- and 1,3-propylene glycol, dipropylene glycol, tripropylene glycol, 1,4-, 1,3- and 2,3-butanediol, neopentyl glycol, 1,6-hexanediol, 1,8-octanediol, 1,10-decanediol, 1,4-cyclohexane dimethanol, 1,4-bis-hydroxymethylcyclohexane, 2-methyl-1,3-propanediol, 250 MW polytetramethylene glycol or mixtures thereof. Small amounts of short chain triols such as trimethylolpropane, trimethylolethane and glycerine or mixtures thereof can also be used. The trimethylene glycol di-(p-aminobenzoate) curative may also be combined with one or more of the polyols described above and contained in the toluene diisocyanate prepolymer. In an embodiment, the curative is at least 90 wt % trimethylene glycol di-(p-aminobenzoate), 99 wt % trimethylene glycol di-(p-aminobenzoate), or essentially only trimethylene glycol di-(p-aminobenzoate).

The polyurethane/urea elastomers of embodiments of the present disclosure may contain the following optional ingredients or additives, such as blowing agents, flame retardants, emulsifiers, pigments, dyes, plasticizers, antioxidants, UV stabilizers, anti-hydrolysis agents, anti-microbial agents, mold release agents, antistatic agents, catalysts, fillers, slip aids, etc.

The polyurethane/urea elastomers of embodiments of the present disclosure may exhibit improved dimensional stability and green strength during the demolding process and throughout the post cure process using trimethylene glycol di-(p-aminobenzoate) as a curative provided that the toluene diisocyanate prepolymers use 2,6-toluene diisocyanate isomer contents of 25% or greater, preferentially 35% or greater, more preferentially 45% or greater, or most preferentially 60% or greater.

Embodiments of the present disclosure are further illustrated but is not intended to be limited by the following examples in which all parts and percentages are by weight unless otherwise specified.

### EXAMPLES AND COMPARATIVE EXAMPLES

### General Synthesis Scheme of Conventional Toluene Diisocyanate (TDI) Prepolymers

### Examples 1-12

The conventional toluene diisocyanate (TDI) based prepolymers were synthesized in the following manner. A three-necked, 1 L round-bottom flask was used as the reaction vessel and it was equipped with a thermocouple to monitor temperature, a mechanical stirrer, and a vacuum source. The reactions were carried out in a nitrogen atmosphere due to the moisture sensitivity of the isocyanates. The polyol or polyol mixture was added to the flask and allowed to mix for at least 5 minutes and heated/cooled until the material was at a temperature of 30-40° C. at which time the TDI was added with the stirrer off. The agitation was restarted and the reaction exotherm monitored to keep the temperature below 70° C. Once the exotherm had completed, the vessel was heated to 80° C. and the reaction was taken to completion as verified by isocyanate (NCO) titration. The material was then degassed under vacuum.

The following list describes the polyols/chain extender used in the Examples and Tables 1-4:
PTMEG 1000=poly(tetramethylene oxide) diol of molecular weight 1000, commercially available from Invista under the trade name Terathane® 1000 or from BASF under the trade name PolyTHF® 1000
PTMEG 650=poly(tetramethylene oxide) diol of molecular weight 650, commercially available from Invista under the trade name Terathane® 650 or from BASF under the trade name PolyTHF® 650
PTMEG 250=poly(tetramethylene oxide) diol of molecular weight 250, commercially available from Invista under the trade name Terathane® 250
EBA 1000=poly(ethylene-butylene) adipate polyester diol of molecular weight 1000, commercially available from BASF under the trade name Lupraphen® 1803/1 or from Panolam Industries International under the trade name Piothane® 50-1000 EBA
EBA 2000=poly(ethylene-butylene) adipate polyester diol of molecular weight 2000, commercially available from BASF under the trade name Lupraphen® 1609/1 or from Panolam Industries International under the trade name Piothane® 50-2000 EBA
PPG 1000=poly(propylene oxide) diol of molecular weight 1000, commercially available from Monument Chemical under the trade name Poly G® 20-112 or Bayer Material Science under the trade name Arcol® PPG-1000
PCL 2000=poly(caprolactone) diol of molecular weight 2000, commercially available from Perstorp under the trade name Capa® 2201
TGDBA=trimethylene glycol di-para amino benzoate, commercially available from Air Products & Chemicals, Inc. under the trade name Versalink® 740M

### Example 1

### Comparative

297.7 g of PTMEG 1000 was added to the reaction flask. To this 102.3 g of 100% 2,4 TDI, available from Bayer Material Science under the trade name Mondur® TDS was added to the flask and rapid stirring begun. The mixture was held at 80° C. until complete as verified by % NCO titration.

### Example 2

297.7 g of PTMEG 1000 was added to the reaction flask. To this 102.3 g of an 80:20 mixture of 2,4:2,6 TDI, available from Bayer Material Science under the trade name Mondur® TDI-80 was added to the flask and rapid stirring begun. The mixture was held at 80° C. until complete as verified by % NCO titration.

### Example 3

297.7 g of PTMEG 1000 was added to the reaction flask. To this 102.3 g of a 65:35 mixture of 2,4:2,6 TDI, available from Bayer Material Science under the trade name Mondur® TD was added to the flask and rapid stirring begun. The mixture was held at 80° C. until complete as verified by % NCO titration.

### Example 4

297.1 g of PTMEG 1000 was added to the reaction flask. To this 102.9 g of a 40:60 mixture of 2,4:2,6 TDI was added to the flask and rapid stirring begun. The mixture was held at 80° C. until complete as verified by % NCO titration.

### Example 5

### Comparative

171.3 g of 1000 EBA and 149.2 g of 2000 EBA were added to the reaction flask and mixed. Then 79.5 g of 100% 2,4 TDI was added and rapid stirring begun. The mixture was held at 80° C. until completion of the reaction as verified by % NCO titration.

### Example 6

The polyol mixture of Example 5 was added to a flask and mixed. To this 79.5 g of an 80:20 mixture of 2,4 and 2,6 TDI was added. The mixture was held at 80° C. until completion of the reaction as verified by % NCO titration.

### Example 7

The polyol mixture of Example 5 was added to a flask and mixed. To this 79.5 g of a 65:35 mixture of 2,4 and 2,6 TDI was added. The mixture was held at 80° C. until completion of the reaction as verified by % NCO titration.

### Example 8

The polyol mixture of Example 5 was added to a flask and mixed. To this 79.5 g of a 40:60 mixture of 2,4 and 2,6 TDI was added. The mixture was held at 80° C. until completion of the reaction as verified by % NCO titration.

### Example 9

### Comparative

300 g of PPG 1000 was added to a flask. To this 100 g of 100% 2,4 TDI was added and rapid stirring begun. The mixture was held at 80° C. until completion of the reaction as verified by % NCO titration.

### Example 10

300 g of PPG 1000 was added to a flask. To this 100.4 g of a 40:60 mixture of 2,4 and 2,6 TDI was added and rapid stirring begun. The mixture was held at 80° C. until completion of the reaction as verified by % NCO titration.

### Example 11

### Comparative

341.9 g of PCL 2000 was added to a flask. To this 58.2 g of 100% 2,4 TDI was added and rapid stirring begun. The mixture was held at 80° C. until completion of the reaction as verified by % NCO titration.

### Example 12

341.9 g of PCL 2000 was added to a flask. To this 58.5 g of a 40:60 mixture of 2,4 and 2,6 TDI was added and rapid stirring begun. The mixture was held at 80° C. until completion of the reaction as verified by % NCO titration.

### General Synthesis Scheme of Low Free TDI Monomer Prepolymers

### Examples 13-17

The low free TDI monomer prepolymers of embodiments of the disclosure were synthesized in the following manner. A three-necked 1 L round bottom flask was used as the reaction vessel and it was equipped with a thermocouple to monitor temperature, a mechanical stirrer, and a vacuum source. The reactions were carried out in a nitrogen atmosphere due to the moisture sensitivity of the isocyanates. The polyol or polyol mixture was added to the flask and allowed to mix for at least 5 minutes and heated/cooled until the material was at a temperature of 30-40° C. at which time the TDI was added with the stirrer off. The agitation was restarted and the reaction exotherm monitored to keep the temperature below 70° C. Once the exotherm had completed, the vessel was kept at 68° C. and the reaction was taken to completion as verified by NCO titration. The material was then kept at 60° C. and put through a wiped film evaporator (WFE) under high vacuum to remove any TDI monomer to a level less than 0.1%. The temperature of the evaporator was 150° C. and the vacuum was less than 300 mTorr.

### Example 13

### Comparative

309.3 g of PTMEG 1000 was added to the reaction flask. To this 190.8 g of an 80:20 mixture of 2,4 and 2,6 TDI was added and rapid stirring begun. The material was reacted at 68° C. until completion of the reaction. The TDI monomer was then removed from the prepolymer in a WFE to a level less than 0.1%.

### Example 14

309.3 g of PTMEG 1000 was added to the reaction flask. To this 190.8 g of an 65:35 mixture of 2,4 and 2,6 TDI was added and rapid stirring begun. The material was reacted at 68° C. until completion of the reaction. The TDI monomer was then removed from the prepolymer in a WFE to a level less than 0.1%.

### Example 15

308.6 g of PTMEG 1000 was added to the reaction flask. To this 191.4 g of a 40:60 mixture of 2,4 and 2,6 TDI was added and rapid stirring begun. The material was reacted at 68° C. until completion of the reaction. The TDI monomer was then removed from the prepolymer in a WFE to a level less than 0.1%.

### Example 16

### Comparative

250.8 g of PTMEG 650 and 33.7 g of PTMEG 250 were added to a flask and mixed. To this 315.7 g of an 80:20 mixture of 2,4 and 2,6 TDI was added and rapid stirring begun. The material was reacted at 68° C. until completion of the reaction. The TDI monomer was then removed from the prepolymer in a WFE to a level less than 0.1%.

### Example 17

250.7 g of PTMEG 650 and 33.6 g of PTMEG 250 were added to a flask and mixed. To this 316.2 g of a 40:60 mixture of 2,4 and 2,6 TDI was added and rapid stirring begun. The material was reacted at 68° C. until completion of the reaction. The TDI monomer was then removed from the prepolymer in a WFE to a level less than 0.1%.

### Polyurethane/Urea Elastomer Preparation

All of the above polyisocyanate prepolymers were held at 70-85° C. Then they were mixed and cured with trimethylene glycol di-para amino benzoate (TGDAB) at an equivalence ratio (NCO:NH) of 1.05. The TGDAB was melted and heated to 145°-160° C. before addition to the prepolymer. The mixture was cast in a preheated mold at 100° C. and demolded as soon as the elastomer had solidified even though the green strength was poor. From the mold, 1.1″ dia.×0.5″ thick cylinders were obtained. All materials were post-cured at 100° C. for a period of 16-20 hours.

### Polyurethane/Urea Elastomer Testing

All the above elastomer samples were tested for hardness (ASTM D-2240) to determine their dimension stability or green strength. An initial reading was measured as well as a reading approximately three seconds after the initial indentation. The measurements were taken on samples after demold, throughout the curing process, and after they were fully post-cured.

TABLE 1

| | EXAMPLE | | | |
|---|---|---|---|---|
| | 1 | | | |
| | (Comparative) | 2 | 3 | 4 |
| Polyol 1 | PTMEG 1000 | PTMEG 1000 | PTMEG 1000 | PTMEG 1000 |
| 2,6-TDI Isomer, % | 0 | 20 | 35 | 60 |
| Prepolymer Type | Conventional | Conventional | Conventional | Conventional |
| % NCO | 5.82 | 5.77 | 5.89 | 5.79 |
| Chain Extender | TGDAB | TGDAB | TGDAB | TGDAB |
| 100° C. | | | | |
| Hardness, Shore A | | | | |
| (initial/3 seconds) | | | | |
| @ Time cured | | | | |
| (min.) | | | | |
| 5 | | 35/22 | 50/40 | 70/63 |
| 7.5 | | 60/52 | 70/64 | 81/78 |
| 10 | | 75/67 | 80/77 | 88/86 |
| 12.5 | | 80/75 | 85/83 | 90/89 |
| 15 | | 82/80 | 80/77 | 90/89 |
| 25 | | 87/86 | 87/86 | 91/91 |
| 35 | | 90/90 | 90/90 | 94/94 |
| 60 | 30/20 | | | |
| 70 | 30/20 | | | |
| 95 | 40/30 | | | |
| 120 | 45/35 | | | |
| Final Hardness, | | | | |
| Shore | | | | |
| @25° C. | 80A/75A | 51D/49D | 52D/50D | 54D/52D |
| (initial/3 | | | | |
| seconds) | | | | |
| @100° C. | 64A/64A | 45D/43D | 46D/45D | 48D/47D |
| (initial/3 | | | | |
| seconds) | | | | |

TABLE 2

| | EXAMPLE | | | |
|---|---|---|---|---|
| | 5 | | | |
| | (Comparative) | 6 | 7 | 8 |
| Polyol 1 | EBA 1000 | EBA 1000 | EBA 1000 | EBA 1000 |
| Polyol 2 | EBA 2000 | EBA 2000 | EBA 2000 | EBA 2000 |
| Polyol 1:2 | 53.4:46.6 | 53.4:46.6 | 53.4:46.6 | 53.4:46.6 |
| Wt Ratio | | | | |
| 2,6-TDI Isomer, % | 0 | 20 | 35 | 60 |
| Prepolymer Type | Conventional | Conventional | Conventional | Conventional |
| % NCO | 4.38 | 4.36 | 4.44 | 4.37 |
| Chain Extender | TGDAB | TGDAB | TGDAB | TGDAB |
| 100° C. | | | | |
| Hardness, Shore A | | | | |
| (initial/3 seconds) | | | | |
| @ Time cured | | | | |
| (min.) | | | | |
| 7.5 | | | 50/37 | 60/55 |
| 10 | | 55/46 | 65/55 | 70/66 |
| 12.5 | | 65/55 | 69/64 | 75/71 |
| 15 | | 68/61 | 73/68 | 80/77 |
| 17.5 | | 70/65 | 75/71 | 82/80 |
| 20 | | 74/69 | 79/74 | 83/81 |
| 25 | | 76/73 | 80/78 | 84/83.5 |
| 33 | | 80/77 | 82/81 | 87/86.5 |
| 60 | 10/0 | | | |
| 90 | 20/10 | | | |
| Final Hardness, | | | | |
| Shore A | | | | |
| @25° C. | 73/65 | 93/93 | 94/94 | 95/95 |
| (initial/3 | | | | |
| seconds) | | | | |
| @100° C. | 51/50 | 90/90 | 92/92 | 93/93 |
| (initial/3 | | | | |
| seconds) | | | | |

TABLE 3

| | EXAMPLE | | | |
|---|---|---|---|---|
| | 9 | | 11 | |
| | (Comparative) | 10 | (Comparative) | 12 |
| Polyol 1 | PPG 1000 | PPG 1000 | PCL 2000 | PCL 2000 |
| 2,6-TDI Isomer, % | 0 | 60 | 0 | 60 |
| Prepolymer Type | Conventional | Conventional | Conventional | Conventional |
| % NCO | 5.51 | 5.47 | 3.24 | 3.21 |
| Chain Extender | TGDAB | TGDAB | TGDAB | TGDAB |
| 100° C. | | | | |
| Hardness, Shore A | | | | |
| (initial/3 seconds) | | | | |
| @ Time cured | | | | |
| (min.) | | | | |
| 10 | | 52/42 | | 30/15 |
| 12.5 | | 64/56 | | 35/24 |
| 15 | | 70/64 | | 40/30 |
| 17.5 | | 75/68 | | |
| 20 | | 76/70 | | 50/42 |
| 25 | | 77/74 | 0/0* | 58/50 |
| 30 | 0/0* | 81/77 | | 64/58 |
| 35 | | 81/79 | | |
| 40 | | | | 70/65 |
| 60 | 0/0* | | | 77/75 |
| 95 | | | 0/0* | |
| Final Hardness, | | | | |
| Shore A | | | | |
| @25° C. | 93/87 | 93/93 | 57/54 | 88/88 |
| (initial/3 | | | | |
| seconds) | | | | |
| @100° C. | 47/42 | 91/91 | 52/50 | 87/87 |
| (initial/3 | | | | |
| seconds) | | | | |

*Material was not demoldable

TABLE 4

| | EXAMPLE | | | | |
|---|---|---|---|---|---|
| | 13 | | | 16 | |
| | (Comparative) | 14 | 15 | (Comparative) | 17 |
| Polyol 1 | PTMEG 1000 | PTMEG 1000 | PTMEG 1000 | PTMEG 650 | PTMEG 650 |
| Polyol 2 | | | | PTMEG 250 | PTMEG 250 |
| Polyol 1:2 | | | | 88.2:11.8 | 88.2:11.8 |
| Wt Ratio | | | | | |
| 2,6-TDI Isomer | 20 | 35 | 60 | 20 | 60 |
| Prepolymer Type | Low Free TDI | Low Free TDI | Low Free TDI | Low Free TDI | Low Free TDI |
| % NCO | 5.98 | 6.01 | 5.77 | 8.87 | 8.69 |
| Chain Extender | TGDAB | TGDAB | TGDAB | TGDAB | TGDAB |
| 100° C. | | | | | |
| Hardness, Shore A | | | | | |
| (initial/3 seconds) | | | | | |
| @ Time cured | | | | | |
| (min.) | | | | | |
| 10 | | | 80/76 | | |
| 12.5 | | | 84/81 | | |
| 15 | | | 89/87 | | |
| 17.5 | | | 91/90 | | |
| 20 | | 35/15 | 92/91 | 45/30 | 70/62 |
| 25 | | 70/60 | 93.5/93 | | |
| 30 | | 86/83 | 94/93.5 | 50/42 | 81/78 |
| 35 | | 90/89 | | | |
| 40 | | 92/91.5 | | 60/52 | 87/85 |
| 45 | 20/0 | | | | |
| 50 | | | | 64/55 | 90/89 |
| 60 | 35/20 | | | 65/59 | 91/91 |
| 90 | 65/55 | | | | |
| 120 | 80/77 | | | | |
| Final Hardness, | | | | | |
| Shore | | | | | |
| @25° C. | 95A/95A | 52D/50D | 56D/55D | 75D/74D | 75D/74D |
| (initial/3 | | | | | |
| seconds) | | | | | |
| @100° C. | 85A/85A | 45D/44D | 50D/49D | 75A/74A | 50D/49D |
| (initial/3 | | | | | |
| seconds) | | | | | |

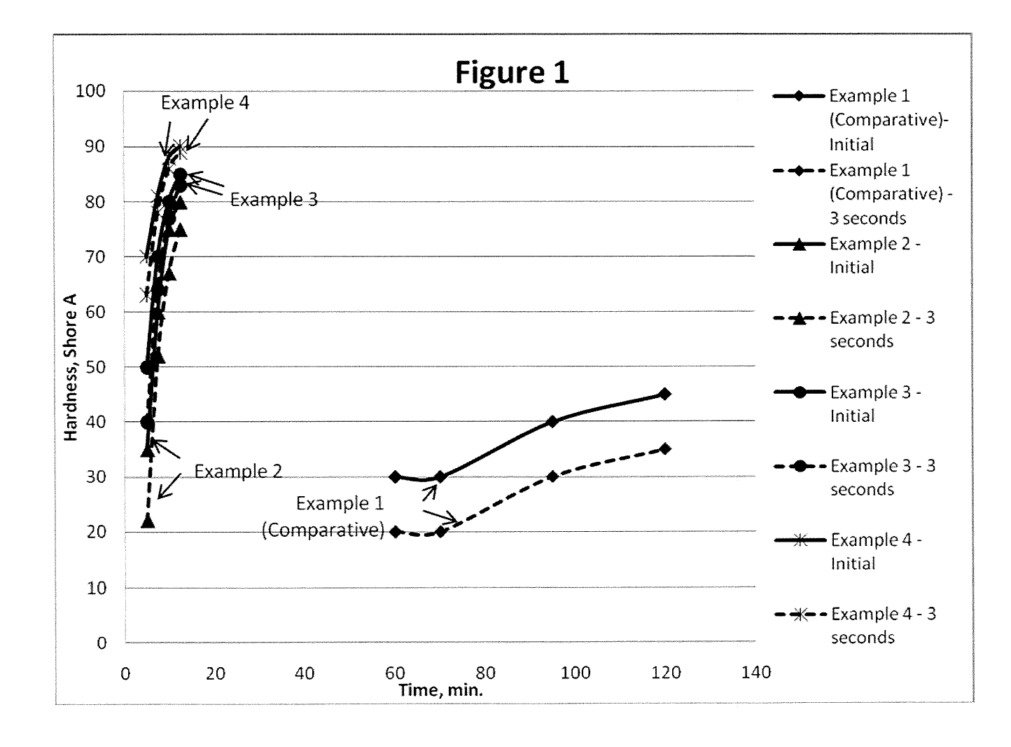

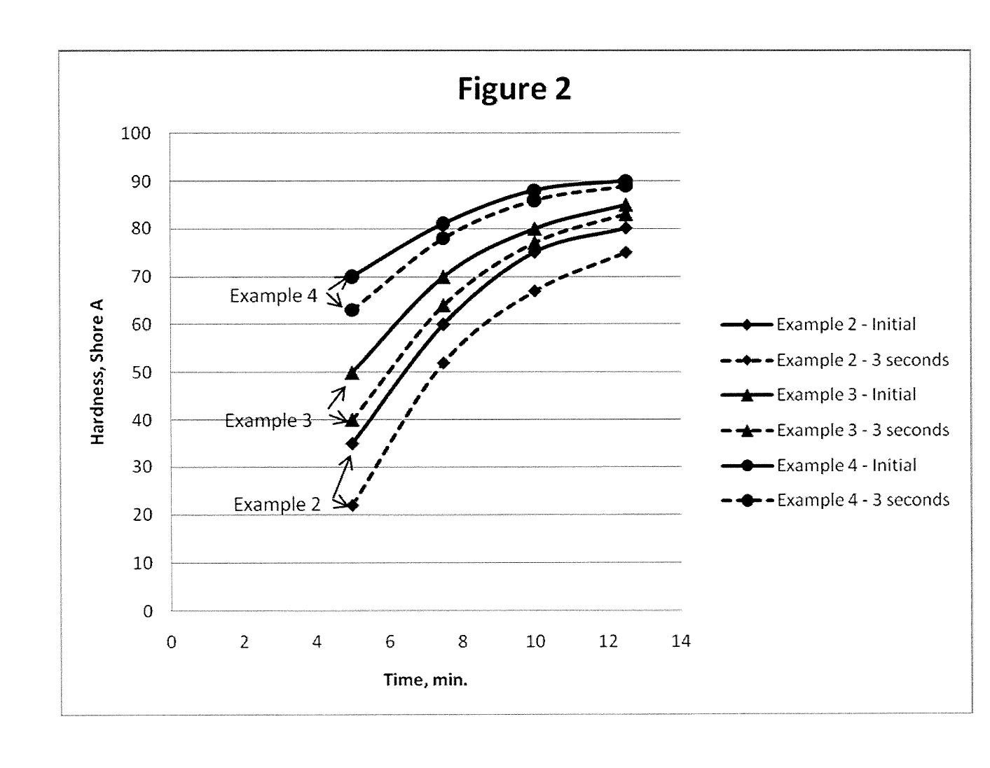

Example 1 (Comparative) and Examples 2-4 in Table 1 illustrate the effect of % 2,6-TDI isomer content on a PTMEG-based prepolymer cured with TGDAB. The Shore A hardness measurements show the “drift” of the hardness by looking at the difference between the initial hardness and the 3 second hardness. Example 1 (Comparative) was not demoldable until 60 minutes due to poor dimensional stability and poor green strength. The hardness drift was 10 Shore A units initially and at each measurement through 120 minutes. Examples 2-4 were all demoldable at 5 minutes. The initial drift on Examples 2-4 started at 7 to 10 Shore A units, but quickly decreased to zero, especially as the 2,6-TDI isomer content was increased. FIGS. 1 and 2 illustrate these results graphically. FIG. 1 is a graph of Examples 1-4 showing hardness increase during the curing process. Both the initial and 3 second hardness are plotted. Example 1 (Comparative) shows a very slow increase in hardness over time and a large drift of approximately 10 Shore A units after 3 seconds. FIG. 2 illustrates only Examples 2-4 which are according to embodiments of the disclosure. At 12.5 minutes cure time, the drift went from 5 units to 2 units to 1 unit as the 2,6-TDI isomer content went from 20% to 35% to 60%. After a full 12 to 16 hour post cure at 100 C, Example 1 (Comparative) still had a 5 unit drift in final hardness at 25 C and was much softer than the elastomers from Examples 2-4 according to embodiments of the disclosure.

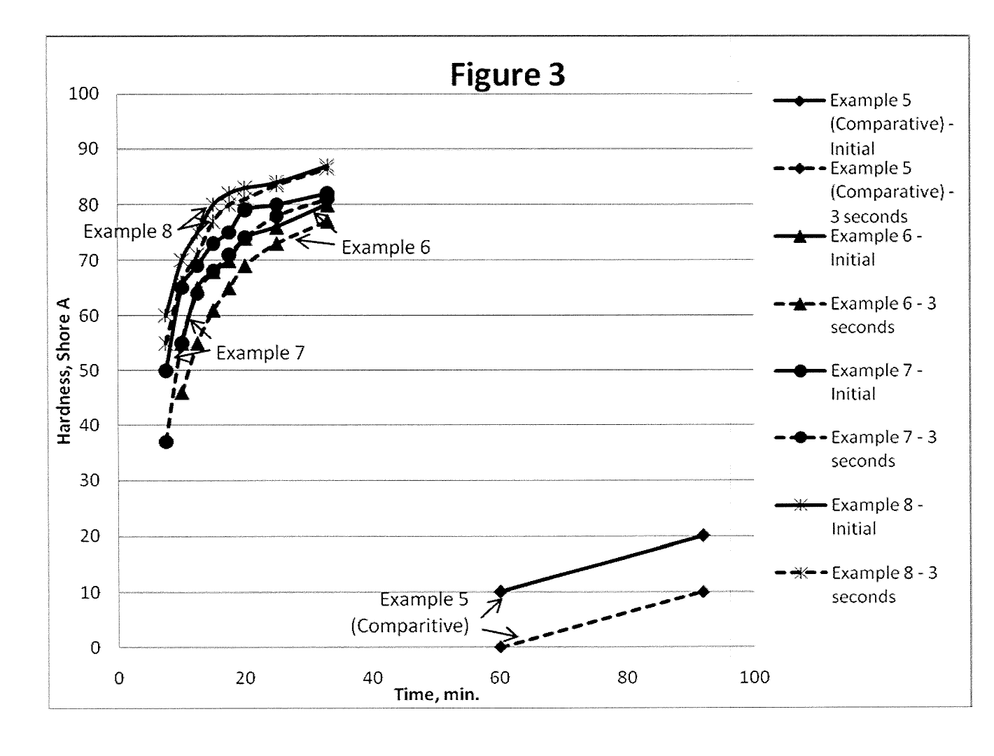

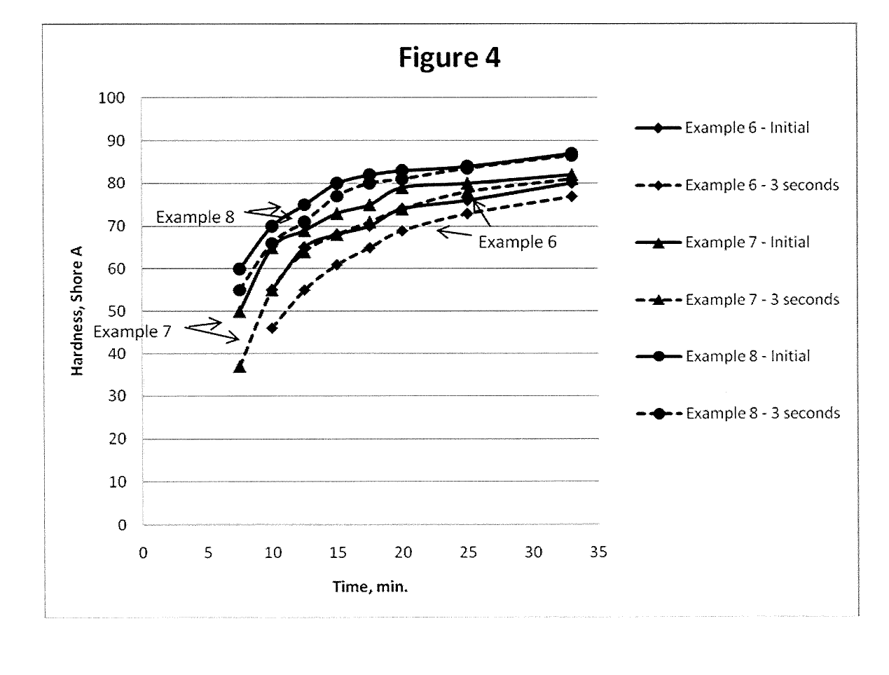

Table 2 shows Example 5 (Comparative) and Examples 6-8 using TDI prepolymers of various 2,6-TDI isomer contents based on an ethylene-butylene adipate polyester. Table 2 demonstrates the same trends as in Table 1. The data is represented graphically in FIGS. 3 and 4. FIG. 3 is a graph with Example 5 (Comparative) and Examples 6-8 while FIG. 4 illustrates just Examples 6-8. Table 2 and FIG. 3, clearly shows a dramatic improvement in dimensional stability and green strength in going from 0% 2,6-TDI isomer to 20% 2,6-TDI isomer. FIG. 4 shows that the dimensional stability continues to improve in going from 20% 2,6-TDI isomer on up to 60% 2,6-TDI isomer content. After the full 12 to 16 hour post cure time, there was still a high hardness drift at 25 C in Example 5 (Comparative), whereas Examples 6-8 according to embodiments of the disclosure had no drift.

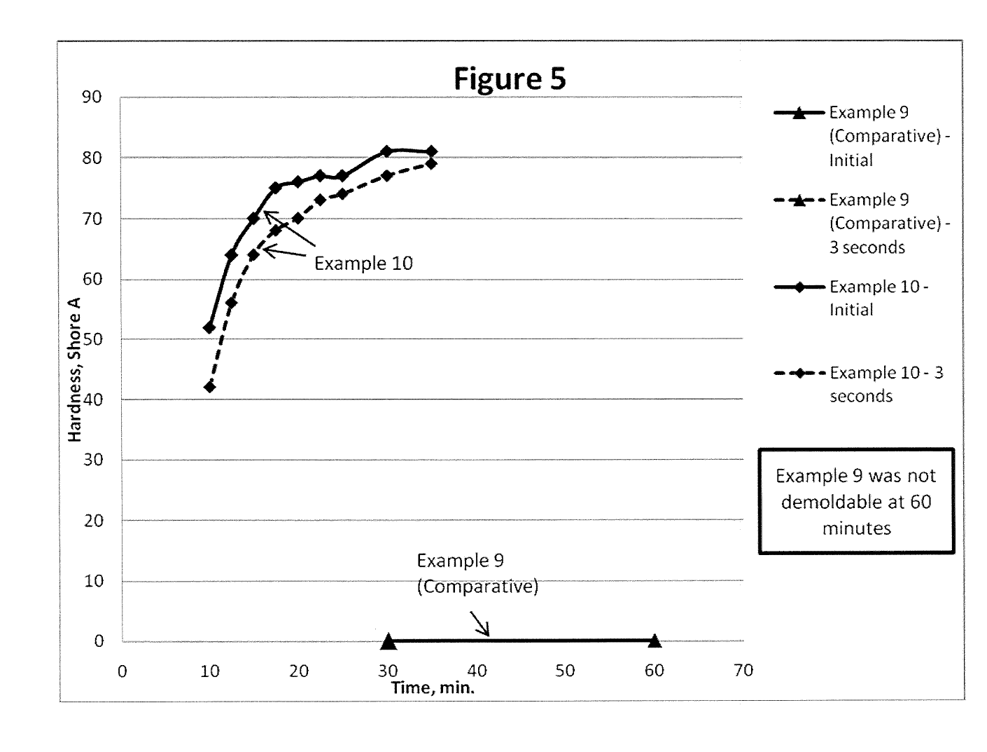

Example 9 (Comparative) and Example 10 in Table 3 compare TDI prepolymers based on PPG polyol made with 0% 2,6-TDI and 60% 2,6-TDI isomer contents, respectively. Example 9 (Comparative) could not be demolded at 60 minutes and was left in the mold for the full 12 to 16 hour post cure at 100 C, whereas Example 10 was demolded in 10 minutes and was above 80 Shore A after just 30 minutes. FIG. 5 shows the hardness versus cure time. Even after a full 12 to 16 hour post cure at 100 C, Example 9 (Comparative) still had a 6 unit drift while Example 10 according to an embodiment of the disclosure had no hardness drift.

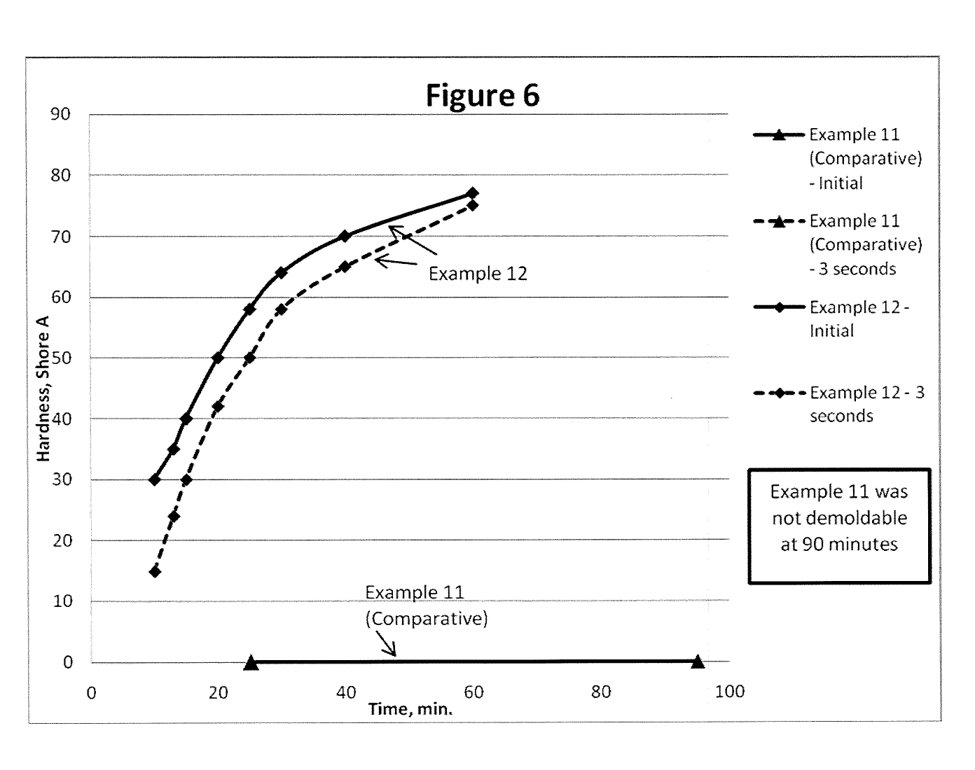

Example 11 (Comparative) and Example 12 in Table 3 compare TDI prepolymers based on polycaprolactone polyol made with 0% 2,6-TDI and 60% 2,6-TDI isomer contents, respectively. Example 11 (Comparative) could not be demolded after 95 minutes, whereas Example 12 according to an embodiment of the disclosure was demolded after just 10 minutes. FIG. 6 shows the hardness versus cure time. After a full 12 to 16 hour post cure at 100 C, Example 11 (Comparative) still had a 3 unit drift and was significantly softer than Example 12 according to an embodiment of the disclosure.

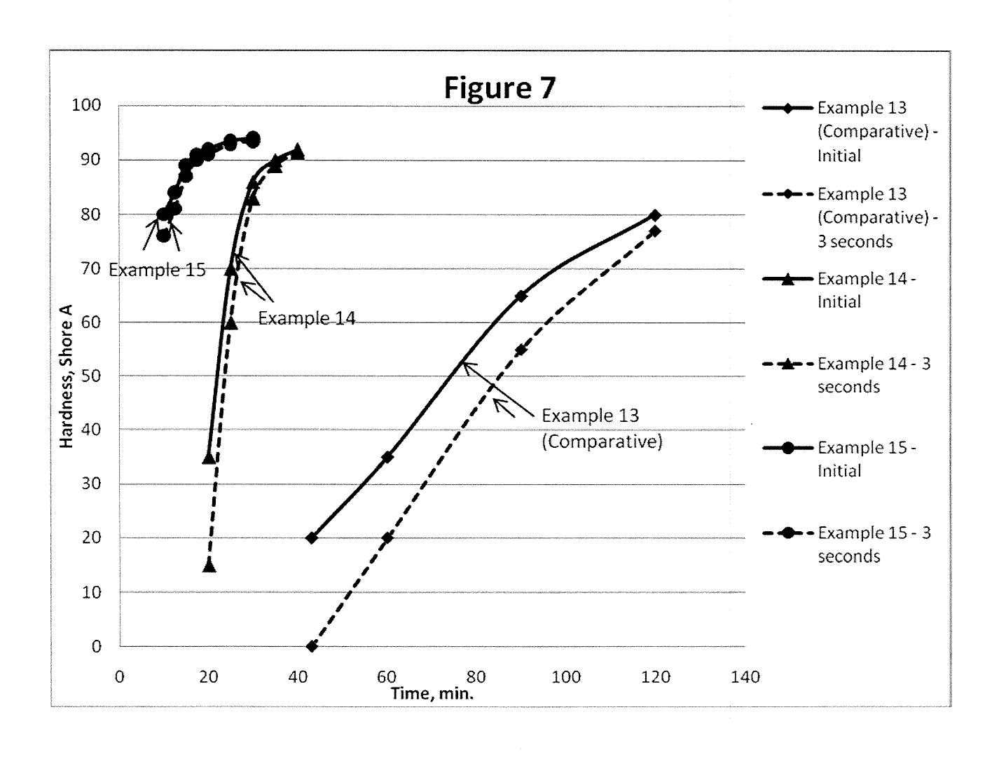

Example 13 (Comparative) and Examples 14 and 15 in Table 4 show the effect of 2,6-TDI isomer content in a low free TDI prepolymer based on PTMEG with TDI monomer contents of less than 0.1 weight %. Example 13 (Comparative) and Examples 14 and 15 have a backbone with PTMEG 1000 and approximately a 6% isocyanate content. Example 13 (Comparative) made with 20% 2,6-TDI isomer content had a long demold time and large hardness drift, whereas Example 14 with a 35% 2,6-TDI isomer content was much improved. Example 15 made with a 60% 2,6-TDI isomer content was even more superior with a demold time of 10 minutes and a hardness of 80 Shore A. FIG. 7 shows that Examples 14-15 according to embodiments of the disclosure have a much faster hardness build and lower drift than Example 13 (Comparative) indicating an improved dimensional stability or green strength.

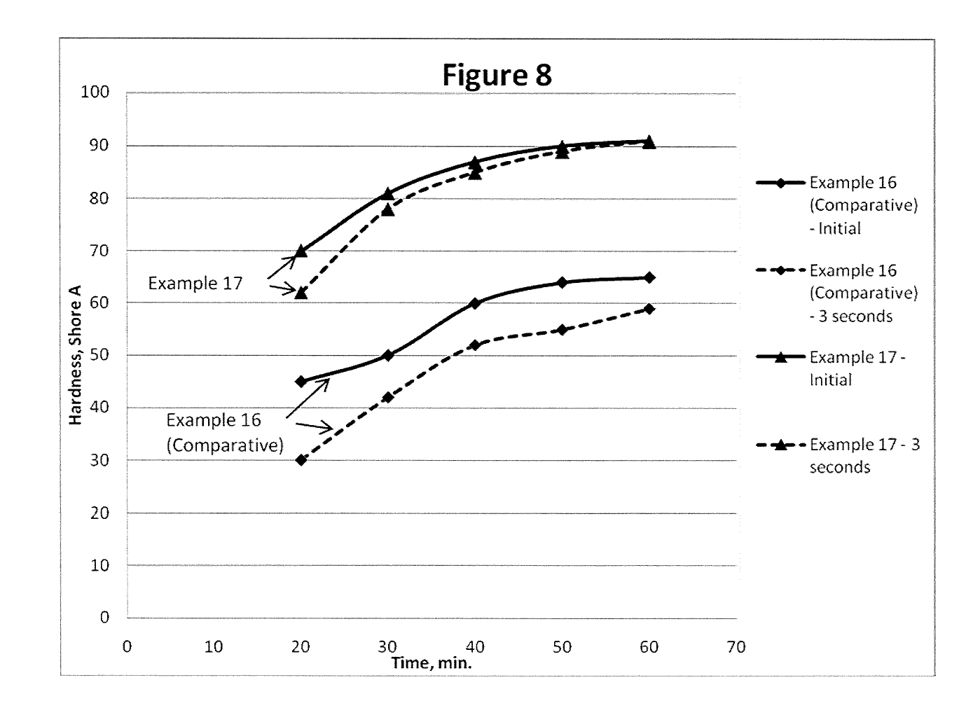

In Table 4, Example 16 (Comparative) and Example 17 show the effect of 2,6-TDI isomer content in a low free TDI prepolymer based on PTMEG with TDI monomer contents of less than 0.1 weight %. Example 16 (Comparative) and Example 17 have isocyanate contents of about 8.7%. The results show that at 20 minutes the hardness drift for Example 16 (Comparative) is approximately double that of Example 17 according to an embodiment of the disclosure and the hardness lower. FIG. 8 shows this graphically. After a full 12 to 16 hour post cure at 100 C, the materials have an identical hardness at 25 C, but at an elevated temperature of 100° C., Example 16 (Comparative) is only a 75 A, whereas Example 17 according an embodiment of to the disclosure is still fairly rigid at 50 Shore D. Example 16 (Comparative) had very poor dimensional stability at elevated temperatures and would need to be put in fixtures in order to not deform and retain its intended dimensions.

In all the preceding examples, the materials with higher 2,6 TDI isomer content have a much quicker demold time, better dimensional stability and green strength, and higher hardness during the curing process and after a full 12 to 16 hour post cure than the systems with lower 2,6 TDI isomer contents.

The polyurethane/urea elastomers of embodiments of the present disclosure is a combination of TDI and various diols with trimethylene glycol di-para amino benzoate as a chain extender. Higher 2,6 TDI promotes improved dimensional stability of the elastomer eliminating the need for special demolding requirements such as clamping fixtures to prevent the elastomer from changing its shape. This leads to improved parts and shorter production times.

Although embodiments of the present invention have been described in detail in the above mentioned examples for the purpose of illustration, it is to be understood that such detail is solely for that purpose and that variations can be made therein by one skilled in the art without departing from the spirit or scope of the present invention except as it may be limited by the claims. The invention illustratively disclosed herein may be suitably practiced in the absence of an element which is not specifically disclosed herein.

What is claimed is:

1. A polyurethane/urea elastomer composition comprising the reaction product of:
a. a toluene diisocyanate prepolymer composition being prepared by the reaction of:
i. toluene diisocyanate with at least 25% by weight of 2,6-isomer with
ii. a polyol selected from the group consisting of polyalkylene oxide, polyester, polycaprolactone, polybutadiene, polycarbonate, polycarbonate ester and mixtures thereof; and
iii. optionally, a short chain diol up to about 70% equivalents based on the total equivalents of polyol and short chain diol; and
b. a chain extender comprising trimethylene glycol di-(p-aminobenzoate),
said polyurethane/urea elastomer composition having a toluene diisocyanate prepolymer to amine equivalent ratio of from about 0.80 to 1.20, and said toluene diisocyanate prepolymer composition has an isocyanate group content from about 1% to about 12% by weight.

2. The polyurethane/urea elastomer composition of claim 1 wherein the toluene diisocyanate prepolymer composition is based on toluene diisocyanate with at least 35% by weight of the 2,6-isomer.

3. The polyurethane/urea elastomer composition of claim 1 wherein the toluene diisocyanate prepolymer composition is based on toluene diisocyanate with at least 45% by weight of the 2,6-isomer.

4. The polyurethane/urea elastomer composition of claim 1 wherein the toluene diisocyanate prepolymer composition is based on toluene diisocyanate with at least 60% by weight of the 2,6-isomer.

5. The polyurethane/urea elastomer composition of claim 1 wherein the toluene diisocyanate prepolymer composition has an isocyanate/hydroxyl (NCO/OH) ratio of 1.4 to 2.5.

6. The polyurethane/urea elastomer composition of claim 1 wherein the toluene diisocyanate prepolymer composition has an isocyanate/hydroxyl (NCO/OH) ratio of 1.6 to 2.0.

7. The polyurethane/urea elastomer composition of claim 1 where the polyol or polyol/short chain diol mixture has an average equivalent weight of 200 to 4000.

8. The polyurethane/urea elastomer composition of claim 1 where the polyol is selected from the group consisting of polypropylene oxide, polypropylene oxide with oxyethylene moieties, polytetramethylene ether glycol and mixtures thereof, wherein the polyol has an average equivalent weight of 250 to 2000.

9. The polyurethane/urea elastomer composition of claim 1 where the polyol is a polyester resulting from the reaction of adipic acid and a short chain diol selected from the group consisting of ethylene glycol, 1,2-propylene glycol, 1,3-propylene glycol, 2-methyl-1,3-propanediol, 2,2-dimethyl-1,3-propanediol, 1,4-butanediol, 1,3-butanediol, 1,6-hexanediol, 1,4-cyclohexane dimethanol and mixtures thereof, wherein the polyol has an average equivalent weight of 250 to 2000.

10. The polyurethane/urea elastomer composition of claim 1 wherein the toluene diisocyanate prepolymer to amine equivalent ratio from about 0.95 to 1.10.

11. The polyurethane/urea elastomer composition of claim 1 wherein the toluene diisocyanate prepolymer to amine equivalent ratio from about 1.00 to 1.10.

12. The polyurethane/urea elastomer composition of claim 1 wherein the toluene diisocyanate prepolymer composition has an isocyanate group content from about 2% to about 10% by weight.

13. A polyurethane/urea elastomer composition comprising the reaction product of:
a. a toluene diisocyanate prepolymer composition being prepared by the reaction of:
i. toluene diisocyanate with at least 35% by weight of 2,6-isomer with
ii. a polyol selected from the group polyalkylene oxide, polyester, polycaprolactone, polybutadiene, polycarbonate, polycarbonate ester or mixtures thereof;
iii. optionally, a short chain diol up to about 70% equivalents based on the total equivalents of polyol and short chain diol; and
iv. removing unreacted toluene diisocyanate from the prepolymer reaction product to a level less than about 0.5% by weight; and
b. a chain extender comprising trimethylene glycol di-(p-aminobenzoate),
said polyurethane/urea elastomer composition having a toluene diisocyanate prepolymer to amine or amine/hydroxyl equivalent ratio of from about 0.80 to 1.20, and said toluene diisocyanate prepolymer composition have an isocyanate group content from about 1% to about 12% by weight.

14. The polyurethane/urea elastomer composition of claim 13 wherein the toluene diisocyanate prepolymer composition is based on toluene diisocyanate with at least 45% by weight of the 2,6-isomer.

15. The polyurethane/urea elastomer composition of claim 13 wherein the toluene diisocyanate prepolymer composition is based on toluene diisocyanate with at least 60% by weight of the 2,6-isomer.

16. The polyurethane/urea elastomer composition of claim 13 wherein the toluene diisocyanate prepolymer composition has an equivalence ratio of toluene diisocyanate to polyol or polyol/short chain diol mixture of 2:1 to 20:1.

17. The polyurethane/urea elastomer composition of claim 13 wherein the toluene diisocyanate prepolymer composition has an equivalence ratio of toluene diisocyanate to polyol or polyol/short chain diol mixture of 3:1 to 6:1.

18. The polyurethane/urea elastomer composition of claim 13 where the polyol or polyol/short chain diol mixture has an average equivalent weight of 250 to 4000.

19. The polyurethane/urea elastomer composition of claim 13 where the polyol is selected from the group consisting of polypropylene oxide, polypropylene oxide with oxyethylene moieties, polytetramethylene ether glycol and mixtures thereof, wherein the polyol has an average equivalent weight of 250 to 2000.

20. The polyurethane/urea elastomer composition of claim 13 where the polyol is a polyester resulting from the reaction of adipic acid and a short chain diol selected from the group consisting of ethylene glycol, 1,2-propylene glycol, 1,3-propylene glycol, 2-methyl-1,3-propanediol, 2,2-dimethyl-1,3-propanediol, 1,4-butanediol, 1,3-butanediol, 1,6-hexanediol, 1,4-cyclohexane dimethanol or mixtures thereof, wherein the polyol has an average equivalent weight of 250 to 2000.

21. The polyurethane/urea elastomer composition of claim 13 wherein the toluene diisocyanate prepolymer composition contains unreacted toluene diisocyanate to a level of less than about 0.5% by weight.

22. The polyurethane/urea elastomer composition of claim 13 wherein the toluene diisocyanate prepolymer composition contains unreacted toluene diisocyanate to a level of less than about 0.10% by weight.

23. The polyurethane/urea elastomer composition of claim 13 wherein the toluene diisocyanate prepolymer to amine equivalent ratio is from about 0.95 to 1.10.

24. The polyurethane/urea elastomer composition of claim 13 wherein the toluene diisocyanate prepolymer to amine equivalent ratio is from about 1.00 to 1.10.

25. The polyurethane/urea elastomer composition of claim 13 wherein the toluene diisocyanate prepolymer composition has an isocyanate group content from about 2% to about 10% by weight.
